(19) United States
(12) Patent Application Publication
(10) Pub. No.: US 2023/0312801 A1
(43) Pub. Date: Oct. 5, 2023

(54) HIGHLY POROUS POLY(LACTIC ACID) MONOLITHS

(71) Applicant: Technion Research & Development Foundation Limited, Haifa (IL)

(72) Inventors: Rajashekharayya A. SANGURAMATH, Haifa (IL); Michael S. SILVERSTEIN, Haifa (IL)

(73) Assignee: Technion Research & Development Foundation Limited, Haifa (IL)

(21) Appl. No.: 18/020,442

(22) PCT Filed: Aug. 3, 2021
(86) PCT No.: PCT/IL2021/050937

§ 371 Date: Feb. 9, 2023

Related U.S. Application Data
(60) Provisional application No. 63/063,352, filed on Aug. 9, 2020.

(51) Int. Cl. C08F 290/06; C08J 9/28

(52) U.S. Cl. CPC C08F 290/061; C08J 9/28; C08J 2333/14; C08J 2207/10; C08J 2201/028

(57) ABSTRACT

Provided herein is a porous PLA-based monolith having a microstructure templated by an external phase of a HIPE, as well as processes of manufacturing the same and uses thereof.

### RELATED APPLICATION

This application claims the benefit of priority of U.S. Provisional Patent Application No. 63/063,352 filed 9 Aug. 2020, the contents of which are incorporated herein by reference in their entirety.

### FIELD AND BACKGROUND OF THE INVENTION

The present invention, in some embodiments thereof, relates to material science, and more particularly, but not exclusively, to a porous monolith based on poly(lactic acid).

Although tissue engineering has multiple facets and several definitions, it may be adequately defined as the science of persuading the body to regenerate or repair tissues that fail to regenerate or heal spontaneously. The primary objective of tissue engineering is a regeneration or replacement of tissues or organs damaged by disease, injury, or congenital anomalies. At present, tissue engineering repairs damaged tissues and organs with artificial supporting structures called scaffolds or matrices. These are used for attachment and subsequent growth of appropriate cells. During the cell growth gradual biodegradation of the scaffold occurs and the final product is a new tissue with the desired shape and properties.

In the arena of musculoskeletal tissue engineering, various methodologies to achieve this goal are currently under investigation. A majority of these techniques, although not all, involve the use of 3-dimensional synthetic polymeric scaffolds implanted at a tissue defect site. These scaffolds provide a framework for cells to attach, proliferate, and form extracellular matrix. The scaffolds may also serve as carriers for cells, growth factors, and/or other biomolecular signals. In the ideal case, scaffolds should bioabsorb in vivo at a predefined rate so that the 3-dimensional space occupied by the initial scaffold is replaced by regenerated host tissue. Research over the past decade has provided a wealth of knowledge regarding synthetic biodegradable polymeric scaffolds. This information addresses their physical and mechanical properties, architecture, cell-biomaterial interactions, and efficacy in animal models.

Techniques such as freeze drying, fiber bonding, gas foaming, particulate leaching, 3D-printing, and emulsion templating have been adopted to introduce the necessary porosity into polymeric materials. Emulsion templating has become an attractive technique to prepare porous monoliths with controlled porosities, porous structures, and mechanical behaviors. Emulsion templating within water-in-oil (w/o) high internal phase emulsions (HIPEs) has been used to generate macroporous monoliths termed polyHIPEs that are almost always composed of crosslinked polymers. PolyHIPEs based on copolymers of styrene and divinylbenzene were used in a successful commercial 3D cell culture scaffold called Alvetex by ReproCELL. One disadvantage of these scaffolds that limits their use in other applications is the fact that they are not biodegradable.

The materials that are relevant in the category of synthetic biodegradable polymeric scaffolds should form solid, stable porous structures to serve as predesigned three-dimensional scaffolds. They generally do not dissolve or melt under in vitro tissue culture conditions (in an aqueous medium) or when implanted in vivo. Linear aliphatic polyesters, such as poly(glycolic acid) (PGA), poly(lactic acid) (PLA), and their copolymers poly(lactic acid-co-glycolic acid) (PLGA) constitute a family of linear aliphatic polyesters, which are most frequently used in tissue engineering. These polymers degrade through hydrolysis of the ester bonds.

PGA is one of the most widely used scaffolding polymers, because of its relatively hydrophilic nature. PGA degrades rapidly in aqueous solutions or in vivo, and loses mechanical integrity between two and four weeks. It has been processed into nonwoven fibrous fabrics as one of the most widely used scaffolds in tissue engineering today. PLA is also widely used for scaffold fabrication. The extra methyl group in the PLA repeating unit (compared with PGA) makes it more hydrophobic, reduces the molecular affinity to water, and leads to a slower hydrolysis rate. It takes many months or even years for a PLA scaffold or implant to lose mechanical integrity in vitro or in vivo. To achieve intermediate degradation rates between PGA and PLA, various lactic and glycolic acid ratios are used to synthesize PLGAs. These polymers (PLA, PGA, and PLGAs) are among the few synthetic polymers approved by the US Food and Drug Administration (FDA) for certain human clinical applications.

Ma, P. X., and Choi J.-W. [Tissue Eng., 2001, 7, pp. 23-33] reported a processing technique for creation of three-dimensional PLA scaffolds with well-controlled interconnected spherical pores. In their work they used paraffin spheres, fabricated with a dispersion method, that were bonded together through a heat treatment to form a three-dimensional assembly in a mold. PLLA and PLGA were dissolved in a solvent and cast onto the paraffin sphere assembly, and after dissolving the paraffin, a porous polymer scaffold was formed.

Liu, X. and Ma, P. X. [Annals of Biomedical Engineering, 2004, 32(3), pp. 477-486] focus on the selection of polymeric materials, scaffold design, and fabrication techniques. Surface modification of scaffolds is discussed, considering the significant effect of surface chemistry on cells adhesion and function. Many other factors such as cell sources, regulating molecules and their delivery, mechanical stimulation, bioreactor design, in vitro and in vivo cultivation conditions, animal models, and clinical considerations are also mentioned as critically important for successfully engineering bone and other mineralized tissues.

Cameron and co-workers (Busby, W. et al., Polymer International, 2002, 51(10), pp. 871-881) investigated generating porous PLA based on the acrylation of PLA diols. While copolymers with styrene or methyl methacrylate were successfully generated, porous PLA-based polyHIPEs, however, could not be produced. In Cameron's work, the high molecular weight of the PLA oligomers produces highly viscous HIPEs, and a diluent, such as toluene, had to be used. Cameron's polyHIPEs with only 20% PLA underwent 50% shrinkage and exhibited poor mechanical properties, and PLA polyHIPEs with 40% and 60% PLA collapsed and were not porous.

### SUMMARY OF THE INVENTION

Aspects of the present invention are drawn to a truly porous monolithic material that is fully degradable, and is based essentially on poly(lactic acid) (PLA). The porous monolithic material is a polyHIPE that is produced within a w/o HIPE using a four-arm, star-shaped PLA-tetramethacrylate (PLA-TtMA) macromonomer. The herein-disclosed monolithic PLA-TtMA polyHIPE exhibited a highly interconnected, open-cell structure suitable for tissue engineering and controlled release applications. In addition, the polyHIPE degradability and macromolecular structure can be manipulate by copolymerizing the PLA-TtMA macromonomer with other monomers (2-ethylhexyl acrylate (EHA) was used as an example). This much sought-after material now affords PLA-based polyHIPEs, and copolymers of lactide with glycolide and/or caprolactone or copolymers of (meth)acrylated PLA with (meth)acrylated poly(glycolic acid) and/or (meth)acrylated polycaprolactone can be used to fine-tune the mechanical and degradation behavior.

According to an aspect of some embodiments of the present invention there is provided a porous monolith that includes a crosslinked polymer, wherein the crosslinked polymer that includes lactic acid residues, and having a microstructure that is templated by a polymerized high internal phase emulsion (HIPE).

According to some embodiments of the invention, the content of the lactic acid residues in the crosslinked polymer is at least 40 wt %.

According to some embodiments of the invention, the lactic acid residues form a part of a macromonomer residue, and a content of the macromonomer residue in the crosslinked polymer is at least 40 wt %.

According to some embodiments of the invention, the macromonomer is represented by general Formula I:

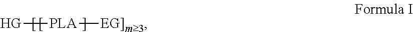

wherein:

HG is a hub-group;

m is a natural number equal or larger than 3;

PLA is a poly(lactic acid) chain; and

EG is an end-group.

According to some embodiments of the invention, the end-group is a diene group, a methacrylic group, an acrylic group, or an allyl group.

According to some embodiments of the invention, the end-group is a methacrylate group.

According to some embodiments of the invention, the hub-group is a polyol group.

According to some embodiments of the invention, the polyol is selected from the group consisting of pentaerythritol, glycerol, erythritol, threitol, sorbitol, galactitol, fucitol, iditol, idose, arabitol, ribitol, mannitol, cyclitol, inositol, pyrogallol, trimethylolpropane, trimethylolmethane, trimethylolethane, di(trimethylolpropane), dipentaerythritol, tripentaerythritol, xylitol, volemitol, isomalt, maltitol, lactitol and maltotriitol.

According to some embodiments of the invention, the polyol is pentaerythritol.

According to some embodiments of the invention:

EG is a methacrylate group;

HG is a pentaerythritol residue;

m is 4; and

n is a positive number greater than 1.

According to some embodiments of the invention, n is 3.

According to some embodiments of the invention, the crosslinked polymer includes residues of an additional monomer, whereas the additional monomer may be, for example, an acrylic ester (acrylate), a methacrylic ester (methacrylate), an unsaturated nitrile, a styrenic monomer, a vinyl ester, a vinyl ether, a conjugated diene, an olefin, a halogenate such as vinyl chloride or vinylidene chloride, an allyl, and any mixture or combination thereof.

According to some embodiments of the invention, the additional monomer is 2-ethylhexyl acrylate.

According to some embodiments of the invention, the porous monolith provided herein is further characterized by at least one of:

a density lower than 0.3 g/cc;

a gel content of at least 50%;

a modulus of at least 0.5 MPa; and/or

a compressive failure strain of at least 10%.

According to an aspect of some embodiments of the present invention there is provided a process of preparing the porous monolith provided herein, the process is effected by:

providing an organic phase that includes a macromonomer having at least three end-groups, the macromonomer includes a plurality of lactic acid residues;

mixing the organic phase with an aqueous phase and a surfactant, thereby obtaining a HIPE; and

polymerizing the HIPE,

thereby obtaining the porous monolith.

According to some embodiments of the invention, the polymerizing is effected by heating the HIPE to a temperature ranging from about 45° C. to about 95° C.

According to some embodiments of the invention, the organic phase further includes an initiator.

According to some embodiments of the invention, the organic phase further includes an organic solvent.

According to some embodiments of the invention, the organic phase further includes an additional monomer.

According to some embodiments of the invention, the aqueous phase further includes a divalent cation.

According to some embodiments of the invention, the process provided herein further includes, subsequent to the polymerizing, subjecting the porous monolith to Soxhlet extraction.

According to some embodiments of the invention, the process provided herein further includes, subsequent to the polymerizing, drying the porous monolith under ambient or reduced pressure and/or under ambient or elevated temperature.

According to an aspect of some embodiments of the present invention there is provided an article of manufacturing that includes the porous monolith provided herein.

According to some embodiments of the invention, the article may be, for example, a tissue scaffold, an implantable medical device, a drug delivery and controlled drug release device and a system for controlled substance release device for agriculture.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D present SEM micrographs of porous structures of exemplary polyHIPEs, according to some embodiments of the present invention, wherein FIGS. 1A-B show PLA-TtMA polyHIPEs, and FIGS. 1C-D show PLA-TtMA-co-EHA;

FIG. 2 presents plots showing the compressive stress-strain curves of the PLA-TtMA and PLA-TtMA-co-EHA polyHIPEs, according to some embodiments of the present invention; and

FIGS. 3A-B present plots showing the degradation behavior of the polyHIPEs, wherein degradation of the PLA-TtMA polyHIPE in 0.1 M NaOH is shown in FIG. 3A, and degradation of the PLA-TtMA-co-EHA polyHIPE in 1 M NaOH is shown in FIG. 3B.

### DESCRIPTION OF SOME SPECIFIC EMBODIMENTS OF THE INVENTION

The present invention, in some embodiments thereof, relates to material science, and more particularly, but not exclusively, to a porous monolith based on poly(lactic acid).

The principles and operation of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As presented hereinabove, production of porous, biodegradable, and biocompatible polymeric materials is highly desired for various biomedical applications such as tissue engineering and controlled drug release. Techniques such as freeze drying, fiber bonding, gas foaming, particulate leaching, 3D-printing, and emulsion templating have been adopted to introduce the necessary porosity into polymeric materials.

The particulate leaching or particle templating approach, best represented by the work of Ma and co-workers [Ma, P. X., and Choi J.-W., Tissue Eng., 2001, 7, pp. 23-33], has been found limited since it must have a built-in particle-to-particle connected path to enable removal of the particles' substance. This requirement leads to severe limitations in the mechanical properties of the resulting monoliths, being too soft and/or too brittle. Generally this approach has been found limited due to the rate a PLA solution can penetrate a mass of closely packed or sintered particles. The particle templating approach is therefore limited to relatively large interconnected cells, dictated by the requirement for complete leaching out of the substance forming the particulate matter, and other limitations associated with the materials and/or the process particle templating approach.

While contemplating the present invention, the inventors have considered emulsion templating for the preparation of porous monoliths with controlled porosities, porous structures, and mechanical behaviors. However, the prior art has it that stable porous polyHIPEs based on PLA-diacrylate alone could not be produced successfully; it seemed that the HIPE stability was not sufficient to ensure mechanical stability of the polyHIPE during polymerization and drying.

While reducing the present invention to practice, a fully degradable, PLA-based polyHIPE has been produced successfully within a w/o HIPS using a four-arm, star-shaped PLA-tetramethacrylate (PLA-TtMA) macromonomer. The PLA-TtMA polyHIPE exhibited a highly interconnected, open-cell structure suitable for tissue engineering and controlled release applications. In addition, it was possible to manipulate the polyHIPE degradability and macromolecular structure by copolymerizing the PLA-TtMA macromonomer with other monomers, such as 2-ethylhexyl acrylate (EHA) or glycolide.

Poly(Lactic Acid)-Based PolyHIPE:

According to an aspect of embodiments of the present invention, there is provided a porous monolith that includes a crosslinked polymer, wherein the crosslinked polymer comprises a plurality of lactic acid residues, and having a microstructure that is templated by a polymerized high internal phase emulsion (HIPE).

In the context of the present invention, the term “monolith” refers to a tangible macroscopic three-dimensional object, which is not limited to any specific form, shape or size, namely not limited to a powder, a film, a fiber, and not limited to a form dependent on any supporting environment, such as a solution, a slurry, a suspension, a colloid, a dispersion, and/or the like. Furthermore, the porous monolith presented herein is HIPE-templated, namely it is a macroscopic composition-of-matter that can take any shape, form or size, hence a monolith, and which is further characterized by a microstructure that is substantially a projection of the microstructure of a HIPE before and after its polymerization. Briefly, a HIPE is a plurality of tightly-packed substantially spheroidal droplets of various sizes, constituting the dispersed phase, separated by walls of a liquid constituting the continuous phase. The average size and size distribution of the droplets is controlled by the chemical composition and mechanical treatment of the emulsion phases, and are typically characterized by a population of one or more narrowly distributed sizes. For example, average droplet size and distribution can be controlled by use of emulsion stabilizers (surfactants; surface-active substances, solid particles etc.), which may act to reduce the tendency of the droplets to coalesce.

Herein, the term “polyHIPE” is used as a structural term to describe a highly porous monolithic structure having thin walls separating a tightly-packed population of voids. The walls are typically thinner at the closest distance between what was tightly-packed droplets before polymerization, and thicker at the spaces between adjacent droplets. When a HIPE is polymerized to yield a polyHIPE, essentially the same microstructure is preserved, and to a great extent the expected shrinkage (present in almost all polymerization events) do not change the essence of the microstructure. It is noted that shrinkage is a change in overall size, and therefore is not seen as altering the microstructure in the sense of morphology. In the sense of dimensions, shrinkage of the HIPE, in the context of embodiments of the present invention, is less than 25%, less than 10%, or less than 5%.

Unlike polymerized foams, which are polymeric structures templated by a mass of bubbles afforded by using a blowing agent and a polymerizable liquid, polyHIPEs are templated by an emulsion, resulting in a microstructure that is easily distinguishable from that of a foam. Hence the term “HIPE-templated” is a structural term rather than a process-related term, since it relates the microstructure of the HIPE to the microstructure of the resulting polymeric porous monolith, which is no longer an emulsion but a solid matter comprising or consisting of a PLA-based polyHIPE.

In some instances, the thinnest areas some of the walls give way to interconnecting windows connecting adjacent voids, thereby forming an open-cell microstructure. In the case of open-cell polyHIPEs, when the dispersed phase is removed and the polyHIPE is dried, the droplets leave voids in their place, which upon polymerization and/or drying become interconnected by the windows in the walls, wherein the voids can be referred to as having an open-cell microstructure. Some type of voids that are typically larger than the droplets, sometimes referred to as “craters”, may stem from gases (e.g., CO₂) released in specific polymerization processes.

By definition, a HIPE exhibits at least 74% internal phase, although, originally, one definition was 70%. When using emulsion templating to produce a porous monolith from medium internal phase emulsions (MIPEs), the internal phase content of a MIPE ranges from 30% to 74%, or from 30% to 70%, while low internal phase emulsions (LIPE) contain internal phase contents that are less than 30%. In the context of embodiments of the present invention, unless stated otherwise, the term “HIPE-templated porous monolith” encompasses, at least in the sense of the structural definition, the microstructure of a HIPE, hence the term HIPE-templated microstructure refers to a microstructure recognizable by interconnected cells separated by thin walls of the polymer.

In the context of some embodiments of the present invention, the phrase “having a microstructure that is templated by a polymerized high internal phase emulsion (HIPE)”, means that the porous monolith provided herein has essentially the same microstructure of the precursor HIPE, and therefore the droplet phase volume fraction of the HIPE corresponds and is essentially equal to the cell/void volume fraction of the polyHIPE. In some embodiments of the present invention, the porous monolith provided herein is templated by a HIPE having at least 74% by volume of the internal phase, or at least 76%, 78%, 80%, 82%, 84%, 86%, 88%, 90%, or 95% by volume. In some embodiments, the volume fraction of the voids/cells in the porous monolith provided herein, that corresponds to volume fraction of the internal aqueous (droplet) phase in the precursor HIPE, ranges from about 0.74 to about 0.95. Alternatively, the volume fraction of the voids/cells in the porous monolith provided herein is at least at least 74%, or at least 76%, 78%, 80%, 82%, 84%, 86%, 88%, 90%, or 95% by volume.

According to some embodiments of the present invention, the microstructure of the polymeric porous monolith is structurally-templated by a water-in-oil high internal phase emulsion, or a w/o HIPE. In a water-in-oil HIPE the polymerization reaction may entrap the dispersed aqueous internal phase, while the polymerized walls serve for the encapsulation thereof.

In the context of embodiments of the present invention, the phrase “HIPE-templated polymeric porous monolith”, is used herein to refer to the presently provided and claimed macroscopic entities, which are characterized by being formed from a crosslinked polymer comprising a plurality of lactic acid residues, and having an open-cell porous microstructure projected by its structural precursor being a high internal phase emulsion (HIPE). The mechanical properties of the porous monolith are derived from its microstructure and chemical composition. The phrase “HIPE-templated polymeric porous monolith” is used herein interchangeably with the shortened phrases “polymeric porous monolith”, “monolithic and porous composition-of-matter”, “HIPE-templated porous monolith”, or just “porous monolith”.

The term “residue” is used herein as it is used in the relevant art of polymer science, and refers to a portion, and typically a major portion of a molecule, which has underwent a chemical reaction and is now covalently linked to another molecular entity. In the context of the present embodiments, a residue is an equivalent term to a monomeric unit within the polymer. In the context of embodiments of the present invention, the term “residue” refers to the part of a monomer that after polymerization is made part of the main-chain of a polymer, or a network thereof. For example, the molecular entity can be an amino acid molecule, and the portion of the amino acid which forms a part of a polypeptide chain (a polymer) after the formation of the polypeptide chain, is an amino acid residue (a monomer). An amino acid residue is therefore that part of an amino acid which is present in a peptide sequence upon reaction of, for example, an alpha-amine group thereof with a carboxylic group of an adjacent amino acid in the peptide sequence, to form a peptide amide bond and/or of an alpha-carboxylic acid group thereof with an alpha-amine group of an adjacent amino acid in the peptide sequence, to form a peptide amide bond. The term “moiety” describes a part, and preferably a major part of a chemical entity or compound, which typically has certain functionality or distinguishing features.

The porous monolith provided herein is essentially a crosslinked polymer shaped as the external phase of a HIPE. As used herein, the term “crosslink” refers to a bond that links one polymer chain to another. These links may take the form of covalent bonds or ionic bonds; preferably, the crosslinks are covalent bonds. Thus, the crosslinked polymer of the porous monolith, according to embodiments of the present invention, is a network of crosslinked (covalently connected) polymer chains that include a plurality of lactic acid residues.

Polymeric compositions which are not crosslinked may deteriorate rapidly as polymer chains are loosely held and increasing the possibility of getting extracted under Soxhlet extraction, resulting in loss of strength, loss of shape, loss of elasticity and recovery, and higher occurrence of vacuoles. An indirect measure of crosslinking is referred to herein and in the art as “gel content”, wherein a relatively high value indicates a highly crosslinked composition. Gel content can be assessed by Soxhlet extraction, as this method is known in the art. Briefly, in gel content determination, the sample is Soxhlet extracted for several hours (e.g., 24 hours) with a solvent that is known to dissolve the type of polymer that is crosslinked in the sample, and the residue is dried and weighed. The amount of gel is expressed as the percentage of the total amount of material which can form the gel.

As discussed hereinabove, one of the objectives of the present invention, is to provide substance that can be used to form artificial supporting structures, called scaffolds or matrices for use in tissue engineering and repairs of damaged tissues and organs. To achieve this objective, the porous monolith, according to embodiments of the present invention, is required to exhibit a certain content of lactic acid residues and certain mechanical properties. According to some embodiments of the present invention, the content of lactic acid residues in the crosslinked polymer is at least 30, 40, 50, 60, 70, 80, or at least 90 weight percent (wt %) of the total weight of the crosslinked polymer. In an exemplary crosslinked polymer, according to some embodiments of the present invention, the repeating unit may be a macromonomer, the majority of which is made of lactic acid residues; thus, according to some embodiments of the present invention, the porous monolith provided herein the content of such a macromonomer residue in the crosslinked polymer is at least 30, 40, 50, 60, 70, 80, or at least 90 in wt % of the total weight of the crosslinked polymer, wherein lactic acid residues form a major part of the macromonomer residue.

As an example for assessing the lactic acid content of a crosslinked polymer, according to embodiments of the present invention, it is assumed that a lactic acid residue has a molecular weight of about 73 g/mol (C₃H₅O₂), and that the macromonomer that is being used to make the crosslinked polymer has a molecular weight of about 2140 g/mol, and 24 copies of lactic acid residues. Assuming that a copolymer is formed with another monomer and that the resulting crosslinked polymer contains 80 wt % residues of the macromonomer, the content of the crosslinked polymer is about 65 wt %: 24*73/2140*0.8=0.65. In another example, a porous monolith made of a crosslinked polymer without EHA contains 100% residues of the macromonomer.

According to some embodiments of the present invention, the crosslinked polymer of the porous monolith provided herein, may include residues of other monomers, additional to the macromonomer presented herein. The additional monomers may be added at any ratio with respect to the macromonomer, however, it is to be understood that for certain applications and uses, the PLA content has to be above a certain level, thus the content of PLA in the compassion-of-matter provided herein, according to some embodiments, is adjusted according to the requirements of any specific application and use thereof.

Additional monomers are optionally added to bestow particular properties to the crosslinked polymer and/or to the porous monolith. For example, monomers that promote or hinder biodegradation the porous monolith; monomers that promote the formation of elastic polymers may be used to bestow elasticity to the porous monolith; monomers that exhibit a certain spectral properties may be added to the porous monolith in order to bestow these spectral properties thereto; monomers that form hydrophobic or hydrophilic polymers may be used in order to fine-tune the hydrophobicity of the porous monolith; certain monomers may be used to manipulate the rheological properties of the HIPE prior to polymerization, in order to achieve certain complex structures requiring specific viscosity during casting; and so on.

Hence, according to some embodiments of the present invention, the crosslinked polymer of the porous monolith presented herein, further includes residues of an additional monomer, preferably free radical polymerizable monomers which are useful in forming a copolymer with the macromonomer of the present invention. Non-limiting examples of free radical polymerizable monomers include, acrylic esters (acrylates), methacrylic esters (methacrylates), unsaturated nitriles, styrenic monomers, vinyl esters, vinyl ethers, conjugated dienes, olefins, halogenated (e.g., vinyl chloride and vinylidene chloride), allyl and other monomers, and mixtures thereof. According to some embodiments, the additional monomer is 2-ethylhexyl acrylate.

In some embodiments of the present invention the mass content of the additional monomer is less than 10, 20, 30, 40, 50, 60, or less than 70 wt % of the crosslinked polymer.

Macromonomer:

According to some embodiments of the present invention, the crosslinked polymer is made primarily or entirely of residues of a PLA-based macromonomer. According to some embodiments, the macromonomer is represented by general Formula I:

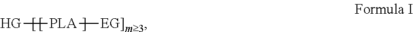

wherein:

HG is a hub-group;

m is a natural number equal or larger than 3;

PLA is a poly(lactic acid) chain; and

EG is an end-group.

The term “hub-group”, as used herein in the context of some embodiments of the present invention, refers to an atom or a group of atoms (a moiety), to which multiple chain of PLA, also referred to herein as arms, are attached. The hub-group is equivalent to a crosslinking node in polymers, and in order to afford a network of connected PLA chains, the hub-group should provide at least three point for such PLA chains to connect to. Preferably, the number of arms connected to the hub-group is three (3) or more, and this is expressed in Formula I by the natural number m, which is equal or larger than 3.

Since the hub-group is connected to PLA chains, the precursor molecule that precedes the hub-group may exhibit a hydroxyl group (—OH), which is known to be reactive towards lactic acid and lactide. Molecules that exhibit a plurality of hydroxyl groups are known as polyols, hence, according to some embodiments of the present invention, the hub-group is a polyol group, namely a residue of a polyol.

Exemplary polyols include, without limitation, pentaerythritol, glycerol, erythritol, threitol, sorbitol, galactitol, fucitol, iditol, idose, arabitol, ribitol, mannitol, cyclitol, inositol, pyrogallol, trimethylolpropane, trimethylolmethane, trimethylolethane, di(trimethylolpropane), dipentaerythritol, tripentaerythritol, xylitol, volemitol, isomalt, maltitol, lactitol and maltotriitol. Preferably, the polyol is pentaerythritol, which exhibits five carbons and four hydroxyl end-groups.

The term “end-group”, as used herein in the context of polymer synthesis and characterization thereof. In polymer chemistry, end groups are functionalities or constitutional units that are at the extremity of a monomeric, macromonomeric or oligomering unit. In polymer synthesis, like condensation polymerization and free-radical types of polymerization, end-groups are commonly used and can be analyzed for example by nuclear magnetic resonance (NMR) to determine the average length of the polymer. Other methods for characterization of polymers where end-groups are used are mass spectrometry and vibrational spectrometry, like infrared and Raman spectrometry. One non-limiting example of an end-group is the acrylate group on each end the polymer poly(ethylene glycol) diacrylate.

According to some embodiments of the present invention, the end-group is a vinyl group, a diene group, a methacrylic group or an acrylic group, however, other end-groups are contemplated within the scope of the present invention. Preferably, the end group is conducive to free radical polymerization; for example, a methacrylate group.

The PLA chain in Formula I represents a poly(lactic acid) chain which can be of any length, and be interrupted by one or more residues of other monomers (non-lactic acid monomers) such as, but not limited to glycolic acid residues; however, practical considerations limit the length of the PLA arms to afform macromonomers that can be manipulated and form a stable HIPE. For example, a macromonomers that exhibits a very long PLA arm(s) of more than 30 lactic acid 30 residues, may be too viscous to form a stable HIPE. Preferably, the PLA chains in Formula I exhibit a length of 2-30 lactic acid residues, more preferably, the number lactic acid residues in the PLA is 4, 6, 8, 10, 12 or 14.

An exemplary macromonomer that can be used to manufacture the porous monolith provided herein, is represented by general Formula I, wherein:

the end-group is a methacrylate group;

HG is a pentaerythritol residue;

m is 4; and

n is a positive number greater than 1. Preferably n is 3, 4, 5, 6, 7, 8, 9, 10, 11, 12, 13, 14, or 15. Such a macromonomer is represented by general Formula II:

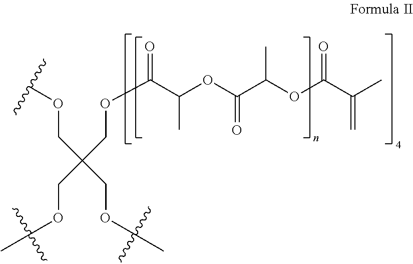

The macromonomer PLA-TtMA has been demonstrated by the present inventors, as presented hereinbelow, and depicted in Scheme 2.

It is noted herein that the macromonomer can be designed to exhibit arms with residues of other monomers, which would alter and fine-tune the properties of the porous monolith; for example, introducing glycolic acid residues to the PLA arms would alter the biodegradability of the porous monolith. An embodiment such as this has been successfully materialized in a macromonomer having copolymeric arms made of 75% lactide and 25% glycolide, which was successfully methacrylated and incorporated into a HIPE using a 50/50 mixture of DMF and toluene in the external phase (PGA is not soluble in toluene; results not shown).

It is within the scope of the present invention to provide macromonomers having glycolic acid residues instead of lactic acid residues. In these embodiments the PLA is replaced with poly(glycolic acid) or PGA, using, for example glycolide instead of lactide, thereby giving rise to a macromonomer having PGA arms.

It is also within the scope of the present invention to form the porous monolith in a copolymerization reaction between different types of macromonomers, for example combining PLA-TtMA with PCL-DMA, or any other (meth)acrylated PCL or with PGA-TtMA, wherein PCL stands for polycaprolactone, a biodegradable polyester and DMA stands for dimethacrylate.

Mechanical Properties:

In order to be capable of performing as a scaffold for tissue engineering, or for any other application, the porous monolith should exhibit certain mechanical properties that are contributive to the tasks and performance required therefrom.

As stated hereinabove, while the prior art provides some porous polymeric monoliths having a high PLA content, none are as mechanically durable, such as in sustaining considerable compressive strain. All known PLA-based monoliths fail under mild compressive strain, and most irreversibly lose their shape altogether when compressed. The unique and advantageous approach for producing the porous monolith provided herein opens the way to design a porous PLA-based monolith of any shape, size, having a wide range of mechanical properties that can be tailor made for specific applications.

The mechanical properties of the porous monolith provided herein is a result of the combination of microstructure and chemical composition. These properties are relevant in the context of the use of the porous monolith, namely if it is used as a dry monolith or a wet/soaked monolith. In general, where referring to features, definitions, properties and characteristics of the porous monolith provided herein, they are considered with respect to the pristine monolith, namely in the dry form thereof, however, the wet/soaked form of the monoliths are contemplated as well.

In the context of embodiments of the present invention, the terms “failure” and “failing” is a mechanical term defined as a non-negligible decrease in stress with increasing strain or a discontinuity in the stress with increasing strain. In some cases, a discontinuity in the stress with increasing strain may be noticeable in a stress/strain plot as a sharp change in the trend of an otherwise smooth curve. A material could “fail” but such a failure might not be visually obvious or otherwise seen as macroscopic structural damage. In some cases, failure may be expressed visibly as breakage or cracks. It is noted that materials may undergo an irreversible deformation (plastic deformation) without failing. The porous monolith presented herein is capable of sustaining a compressive strain of at least 10% before failing (compressive failure strain in percent), when the porous monolith is dry.

In some embodiments, the porous monolith is characterized by a compressive failure strain when dry of at least 10%, 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58%, 60%, 62%, 64%, 66%, 68% or at least 70% when the porous monolith is dry or when wetted by an aqueous medium.

In some embodiments, the modulus of a dry porous monolith is at least 100 kPa, 150 KPa, 200 KPa, 250 KPa, 300 KPa, 350 KPa, 400 KPa, 450 KPa, 500 KPa, 550 KPa, 600 KPa, 650 KPa, 700 KPa, 750 KPa, 800 KPa, 850 KPa, 900 KPa, 950 KPa, 1 MPa, 1.1 MPa, 1.2 MPa, 1.3 MPa, 1.4 MPa, 1.5 MPa, 1.6 MPa, 1.7 MPa, 1.8 MPa, 1.9 MPa, 2 MPa, 2.5 MPa, 3 MPa, 3.5 MPa, 4 MPa, 4.5 MPa, 5 MPa, 10 MPa, 20 MPa, 30 MPa, 40 MPa, 50 MPa, 60 MPa, 70 MPa, 80 MPa, 90 MPa or at least 100 MPa.

According to some embodiments of the present invention, the porous monolith is characterized by at least one of:

a density lower than 0.1, 0.2, 0.3, 0.4, 0.5 or 0.6 g/cc;

a gel content of at least 30%, 40%, 50%, 60%, 70%, or 80%;

a modulus of at least 0.1 MPa, 0.5 MPa, 0.8 MPa, 1 MPa, 2 MPa, 5 MPa or 10 MPa; and/or

a compressive failure strain of at least 10%, 20%, 30%, 40%, 50%, 60%, or 70%.

Process:

The porous monolith presented herein is a polyHIPE, which means that the process of manufacturing the porous monolith involves the preparation of a HIPE, wherein the external phase thereof contains polymerizable monomers, oligomers and/or macromonomers comprising lactic acid or residues thereof.

Thus, according to an additional aspect of embodiments of the present invention, there is provided process of preparing the porous monolith presented herein; the process is effected by:

providing an organic phase that includes a macromonomer having at least three end-groups, as well as a plurality of lactic acid residues;

mixing this organic phase with an aqueous phase and a surfactant, thereby obtaining a HIPE; and

polymerizing the HIPE, thereby obtaining the porous monolith.

As known in the art, affording a stable HIPE is a key stet in affording a polyHIPE, and in the case of PLA-based polyHIPE, the precursor HIPE is not trivial to afford, primarily due to the viscosity of the organic phase. In some embodiments of the present invention, the macromonomer is too viscus to form a HIPE, and it has to be dilute, at least to some extent, in order to successfully firm a stable HIPE. The most effective diluent for the macromonomer is an organic solvent that can solubilize poly(lactic acid) chains. According to some embodiments of the present invention, the organic solvent is toluene, however several other organic solvents are contemplated within the scope of the present invention.

Another option to dilute the macromonomer to a workable viscosity, is to mix it with another monomer, which is then incorporated into the crosslinked polymer. One example which has been demonstrated and presented in the Examples section that follows, is the additional monomer 2-ethylhexyl acrylate; the incorporation of which also affects the mechanical properties of the end product.

The organic and/or the aqueous phase may include other substances that support the HIPE and promote the polymerization reaction that follows HIPE formation, such as a surfactant (i.e., polyglycerol polyricinoleate or PGPR), an initiator (i.e., benzoyl peroxide), and a divalent cation. (i.e., CaCl₂).

Once the HIPE has been formed, it is subjected to polymerization conditions, which depend of the type of polymerization reaction suitable for the macromonomers and the optional additional monomers in the HIPE. For example, for a free radical polymerization mechanism, a suitable initiator would be benzoyl peroxide, and the suitable polymerization conditions would be elevated temperatures. Hence, the process may further include heating said HIPE to a temperature ranging from about 45° C. to about 95° C.

After the polymerization reaction comes to completion, the resulting polymer is subjected to Soxhlet extraction to remove the internal phase and/or other solvents and reactants that were not made part of the crosslinked polymer. Once the leachable matter has been removed by this excessive washing technique, the process may further include a drying step, which can be effected in ambient condition, in elevated temperatures and/or in reduced pressure conditions. The smaller the cells are, the more difficult it is to wash and dry the monolith; however, all the leachable materials and solvents are potentially removable essentially in their entirety.

Uses:

According to some embodiments of an aspect of the present invention, there is provided an article of manufacturing which includes the porous monolith provided herewith.

Non-limiting examples of articles that can be made with the porous monolith provided herewith include a tissue scaffold, an implantable medical device, a drug delivery and controlled drug release device and a system for controlled substance release device for agriculture, and the like.

It is expected that during the life of a patent maturing from this application many relevant PLA-based polyHIPEs monolith will be developed and the scope of the term PLA-based polyHiPE monolith is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non limiting fashion.

### Example 1

PLA-PolyHIPE Synthesis—Materials and Methods

Materials: PLA-tetramethacrylate (PLA-TtMA) macromonomer (Mw=˜2000 g/mol) was synthesized as described elsewhere [Busby, W.; Cameron, N. R.; Jahoda, C. A. B., Polymer International, 2002, 51(10), pp. 871-881; and Brutman, J. P.; Delgado, P. A.; Hillmyer, M. A., Polylactide Vitrimers. ACS Macro Letters, 2014, 3(7), pp. 607-610]. Lactide as a source of lactic acid residues, pentaerythritol as a 4-arm hub-group, tin(II)2-ethylhexanoate, methacryloyl chloride for forming an end-group, 2-ethylhexyl acrylate (EHA) as an additional monomer, benzoyl peroxide (BPO) as an initiator/catalyst, and CaCl₂.6H₂O, were purchased from Sigma Aldrich. Triethylamine (Et₃N) was purchased from Spectrum Chemical. The surfactant was polyglycerol polyricinoleate (PGPR, Palsgaard 4125) from PALSGAARD®. All the chemicals were used as received. Analytical grade dichloromethane (DCM), toluene, and ether were purchased from Bio-Lab Chemicals. The DCM was dried overnight using activated molecular sieves (4 Å) that were purchased from Merck. Deionized water was used throughout this work.

PolyHIPE Synthesis: For the PLA-TtMA polyHIPE (PH), the external phase of the HIPE was prepared by mixing PLA-TtMA, PGPR, and BPO in toluene (a diluent used to reduce the viscosity) for 5 min at 3500 rpm using a SpeedMixer™ DAC-150.1 FVZ.K. The internal phase was an aqueous salt solution. The HIPE was formed by adding the aqueous phase to the organic phase in a single portion, mixing for 10 min at 2500 rpm. The HIPE was then placed for 24 hours in a convection oven at 65° C. to effect polymerization.

Scheme 1 shows the synthesis of the hydroxyl terminated four-arm polylactide and of the PLA-TtMA macromonomers.

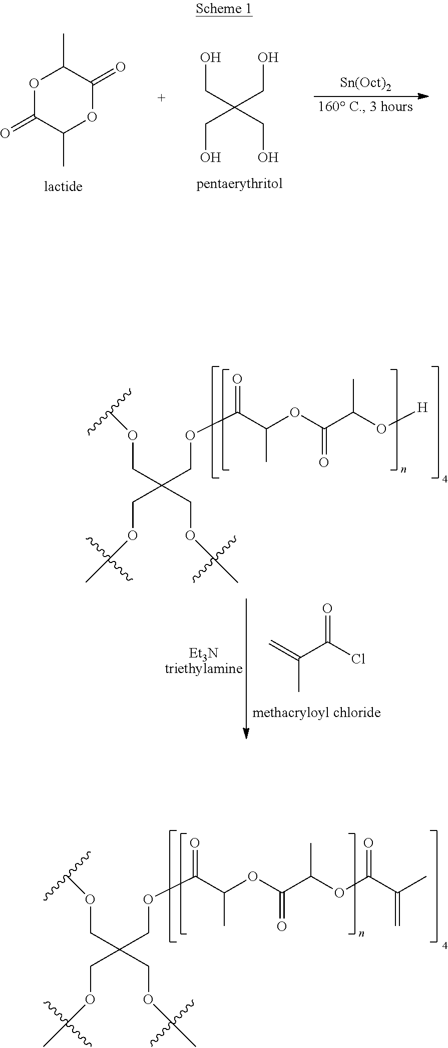

The resulting polyHIPE was cut into cubes (10 mm×10 mm×10 mm) and lyophilized for 72 hours to remove the water and toluene. The polyHIPE was further purified through Soxhlet extraction using ether and then dried at room temperature in a vacuum oven.

The synthesis of the PLA-TtMA-co-EHA was similar except that the toluene was replaced with EHA. The HIPE recipes for the PLA-TtMA and the PLA-TtMA-co-EHA polyHIPEs are listed in Table 1. The PLA-TtMA/EHA mass ratio was 1.2/1.0 and the mole ratio was 1.0/9.1.

Table 1 lists the recipes of the exemplary HIPE/polyHIPE, produced according to some embodiments of the present invention.

TABLE 1

| | | |
|---|---|---|
| Amount, wt % | PLA-TtMA | PLA-TtMA-co-EHA |

External, organic phase

| | | |
|---|---|---|
| PLA-TtMA | 8.10 | 8.28 |
| EHA | — | 6.75 |
| PGPR | 1.54 | 2.81 |
| BPO | 0.81 | 1.21 |
| Toluene | 8.10 | — |
| Total | 18.54 | 19.06 |

Internal, aqueous phase

| | | |
|---|---|---|
| H₂O | 80.97 | 80.41 |
| CaCl₂•6H₂O | 0.49 | 0.54 |
| Total | 81.46 | 80.94 |
| Temperature, ° C. | 65 | 65 |

Characterization: The macroporous structure of the polyHIPEs was characterized using scanning electron microscopy (SEM, FEI E-SEM Quanta 200). Compressive stress-strain measurements were performed on the 10 mm×10 mm×10 mm cubes using an Instron 3345. The measurements were carried out at a strain rate of 10% per minute until a strain of 70% was reached. The static compressive modulus (E) was calculated from the linear slope of the stress-strain curve at low strains.

Degradation: The hydrolytic degradation of the porous monolith provided herein, according to some embodiments of the present invention, was studied as a function of time. For the PLA-TtMA polyHIPE, 0.1 M NaOH was used. For the PLA-TtMA-co-EHA polyHIPE, the hydrolysis was accelerated by using 1 M NaOH. polyHIPE specimens of approximately 10×10×1 mm₃ were placed in vials containing the aqueous NaOH solution (1 mL of the NaOH solution per 2 mg of sample) at room temperature. The samples were removed at specific time intervals, rinsed with deionized water, followed by methanol and ether, and then dried for 3 hours in a vacuum oven at 40° C. The residual mass, the mass of the hydrolyzed specimen divided by the mass of the original specimen, was an average based on three degradation samples.

### Example 2

### Results and Analysis

The four-arm, star-shaped PLA-TtMA macromonomer was prepared in a two-step process as described in the literature (see, Scheme 1). First, the hydroxyl terminated macromonomer was prepared using a bulk ring opening polymerization of lactide using Sn(Oct)₂ as an initiator and pentaerythritol as co-initiator. The feed ratio of lactide monomers to pentaerythritol co-initiator was adjusted to achieve an exemplary and non-limiting molecular weight of about 2000 g/mol. Second, the functionalization of the terminal hydroxyl groups using methacryloyl chloride was performed to produce the PLA-TtMA having four methacrylate end-groups.

The resulting macromonomer in this example had a molecular weight of about 2294 g/mol, as assessed by 1H-NMR (results not shown). Scheme 2 presents one of the possible structures of an exemplary PLA-TtMA macromonomer, having a molecular weight of about 2138 g/mol, based on the atoms in the shown structure; this macromonomer includes the residues of 3 lactide units per arm in 4 arms, each lactide units represents 2 lactic acid units, namely the macromonomer includes residues of 24 lactic acid residues, or the equivalent of a 24-mer PLA chain. It can be said that in this example, the lactic acid content in the macromonomer, in term of weight percent, is about 82%. Hence, in an exemplary polyHIPE wherein the PLA-TtMA content in the crosslinked polymer is about 100 wt %, the lactic acid content is about 82 wt %, since all other components which were part of the HIPE prior to polymerization, are removed in the post-processing steps of Soxhlet extraction and drying, leaving only the except the crosslinked polymer.

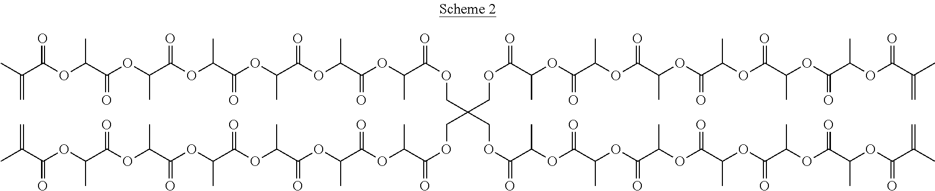 [SMILES: C=C(C)C(=O)OC(C)C(=O)OC(C)C(=O)OC(C)C(=O)OC(C)C(=O)OC(C)C(=O)OC(C)C(=O)OCC(COC(=O)C(C)OC(=O)C(C)OC(=O)C(C)OC(=O)C(C)OC(=O)C(C)OC(=O)C(C)OC(=O)C(=C)C)(COC(=O)C(C)OC(=O)C(C)OC(=O)C(C)OC(=O)C(C)OC(=O)C(C)OC(=O)C(C)OC(=O)C(=C)C)COC(=O)C(C)OC(=O)C(C)OC(=O)C(C)OC(=O)C(C)OC(=O)C(C)OC(=O)C(C)OC(=O)C(=C)C]

It is noted herein that as any polymerization reaction, also the ring-opening and elongation reaction involving lactide is governed by statistically random events, therefore the exact number of lactic acid residues in each arm of the PLA-TtMA macromonomer may vary over a range of numbers, and thus a population of PLA-TtMA macromonomers may include molecules having varying arm-lengths. A method for assessing the number of lactic acid residues in a PLA-TtMA macromonomer include, for example, Gel Permeation Chromatography (GPC), MALDI-TOF Mass Spectroscopy, ¹H-NMR and other means to assess the molecular weight of macromolecules.

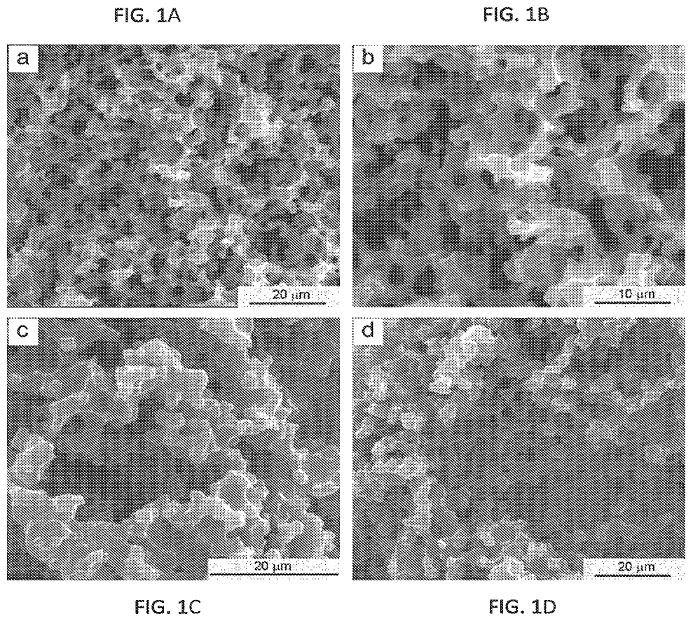

FIGS. 1A-D present SEM micrographs of porous structures of exemplary polyHIPEs, according to some embodiments of the present invention, wherein FIGS. 1A-B show PLA-TtMA polyHIPEs, and FIGS. 1C-D show PLA-TtMA-co-EHA.

Both the PLA-TtMA and PLA-TtMA-co-EHA polyHIPEs were white porous monoliths with relatively low densities (0.15 and 0.27 g/cc, respectively). As can be seen in FIGS. 1A-D, the PLA-TtMA polyHIPE exhibited a highly interconnected structure with larger voids and smaller interconnecting holes (see, SEM micrographs in FIGS. 1A-B) than the PLA-TtMA-co-EHA polyHIPE, which exhibited a less interconnected and relatively irregular porous structure (see, SEM micrographs in FIGS. 1C-D).

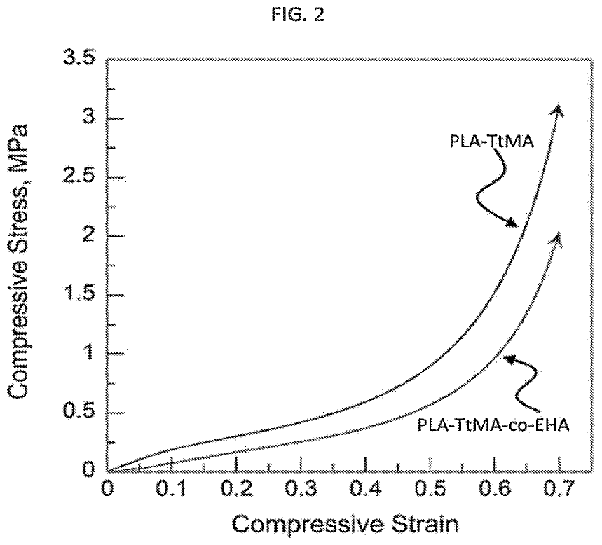

FIG. 2 presents plots showing the compressive stress-strain curves of the PLA-TtMA and PLA-TtMA-co-EHA polyHIPEs, according to some embodiments of the present invention.

The PLA-TtMA and PLA-TtMA-co-EHA polyHIPEs exhibited moduli of 1.4 and 0.92 MPa, respectively. The compressive stress—strain curves of both polyHIPEs were typical of highly interconnected, open-cell porous structures, exhibiting three distinct regions: a linear elastic region at low strains (from which the Young's modulus is derived); a stress plateau region during an accordion-like collapse; and a densification or crushing region at high strains that is characterized by a rapid increase in stress. The polyHIPEs did not fail up to compressive strains of 70%.

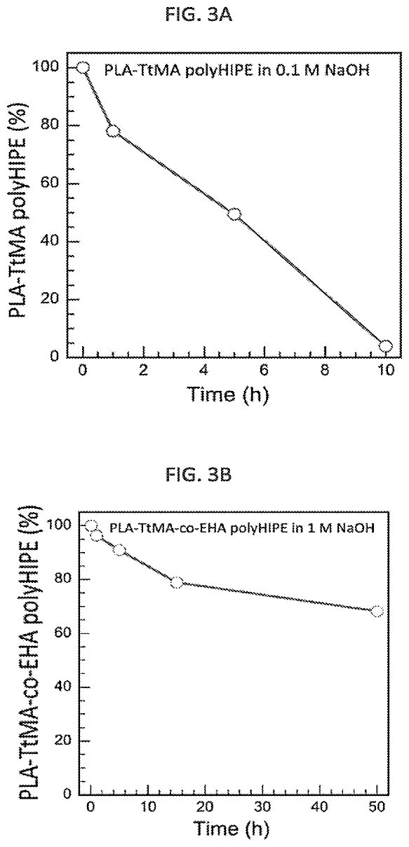

FIGS. 3A-B present plots showing the degradation behavior of the polyHIPEs, wherein degradation of the PLA-TtMA polyHIPE in 0.1 M NaOH is shown in FIG. 3A, and degradation of the PLA-TtMA-co-EHA polyHIPE in 1 M NaOH is shown in FIG. 3B.

For the PLA-TtMA polyHIPE, only 4% of the original mass remained after 10 hours of hydrolytic degradation in 0.1 M NaOH (see, FIG. 3A). The PLA-TtMA-co-EHA polyHIPE, on the other hand, exhibited extremely slow hydrolytic degradation in 0.1 M NaOH and 69% of the mass remained after 50 h of hydrolytic degradation in 1 M NaOH (FIG. 3B). This example exemplifies the control over the degradation rate that can be effected using copolymerization.

The examples provided herein serve as a clear indication for the preparation of PLA-based polyHIPEs, whereas:

i. A highly macroporous, emulsion-templated monolith based on PLA alone was synthesized, and the synthesis was based on a four-arm, star-shaped PLA-TtMA macromonomer;
ii. The PLA-TtMA polyHIPE was a white monolith with a density of 0.15 g/cc and a modulus of 1.4 MPa that could undergo 70% compressive strain without failing;
iii. The PLA-TtMA was fully degradable under mildly basic aqueous conditions; and
iv. The degradability of PLA-TtMA polyHIPE can be manipulated by copolymerization of the PLA-TtMA macromonomer.

### Example 3

### Copolymeric Composition with Poly(Glycolic Acid)

As discussed hereinabove, HIPEs based on biodegradable oligomers such as polyesters can be used to produce biodegradable polyHIPEs (PHs), and can be produced from linear aliphatic polyesters such as poly(lactic acid) (PLA, also polylactide), poly(glycolic acid) (PGA, also polyglycolide) and their copolymers (PLGA, also poly(lactide-co-glycolide)), which are known biodegradable polymers that are often investigated as scaffolds for tissue engineering and as matrices doe drug delivery. The HIPEs based on such oligomers are shown herein to exhibit properties such as a high viscosity and viscoelastic flow that are of interest for 3D printing. The shear thinning at room temperature can enable extrusion, the viscoelasticity can help maintain the HIPS two-phase structure during flow, and the high viscosity can help maintain the extruded shape until polymerization can be effected. Scaffolds with unique architectures, high porosities, and enhanced permeability can be generated through the polymerization of 3D-printed oligomer based HIPEs.

Synthesis of PLA and PLGA Macromers

The synthesis of a PLA-tetrol through ring opening polymerization (ROP) and the subsequent synthesis of a PLA-tetramethacrylate (PLA-TtMA) is illustrated schematically in Scheme 1 hereinabove. The synthesis of the PLGA-tetrol and the PLGA-TtMA used the same procedure but used a lactide to glycolide mass ratio of 3 to 1. Stannous octate (Sn(Oct)₂) was dissolved in a minimal amount of toluene and inserted into flask along with L-lactide with or without glycolide and pentaerythritol (PERYT) (see recipe in Table 2 below).

TABLE 2

| Component | Amount, wt % |
|---|---|
| Sn(Oct)₂ | 0.48 |
| Toluene | 0.78 |
| L-Lactide OR L-Lactide/ | 95.13 |
| Glycolide = 3/1 (mass) | |
| PERYT | 3.61 |

The reaction mixture was heated to 160° C. for 3 hours, then allowed to cool to room temperature and dissolved in an approximately equal volume of dichloromethane. The subsequent solution was precipitated in ether and re-dissolved in an approximately equal volume of dichloromethane (DCM). The resulting polymer was dried in a nitrogen flow for approximately 24 hours and transferred to a polypropylene container.

The tetramethacrylates were synthesized from the tetrols. PLA-tetrol or PLGA-tetrol was dissolved in DCM and trimethylamine. Methacryloyl chloride was taken by glass syringe with Luer taper and Luer needle and added dropwise to PLA-tetrol or PLGA-tetrol solution under nitrogen flow. The reaction was allowed to proceed for overnight at 0° C. in ice bath under flowing nitrogen. The methacryloyl chloride was added after cooling to 0° C. (see the recipe in Table 3 hereinbelow).

TABLE 3

| Component | Amount, wt % |
|---|---|
| PLA-tetrol OR PLGA-tetrol | 6.45 |
| DCM | 83.89 |
| Methacryloyl chloride | 5.88 |
| Triethylamine | 3.78 |

The trimethylamine hydrochloride produced in the reaction was removed by filtration. The remaining solution was repeatedly extracted with a 1% aqueous HCl solution (30 mL×3). The remaining solution was repeatedly extracted with a 3% aqueous NaOH solution (30 mL×3) until the aqueous layer remained colorless. The methylene chloride layer was then collected, dried with anhydrous magnesium sulfate and filtered. The excess solvent was removed and the final product was stored at 0° C.

PolyHIPE Synthesis

The polyHIPEs were synthesized within water-in-oil (w/o) emulsions (see recipe in Table 4 hereinbelow). The HIPE was formed by adding the aqueous phase (water and stabilizing salt (K₂SO₄)) to the organic phase (monomer, solvent, surfactant, and initiator) and mixing. The surfactant was polyglycerol polyricinoleate (PGPR, Palsgaard 4125), the organic-soluble initiator was benzoyl peroxide (BPO, Aldrich) and the organic solvent was toluene (Gadot Ltd, Israel). The HIPEs were polymerized for 24 h at 70° C. The resulting polyHIPEs underwent Soxhlet extraction, first with water for 24 hours and then with ether for 24 hours. Soxhlet extraction is expected to remove the surfactant and residual monomer. The resulting polyHIPEs were dried using vacuum oven.

TABLE 4

| | | |
|---|---|---|
| Amount, wt % | PLA-PH | PLGA-PH |

External, organic phase

| | | |
|---|---|---|
| PLA-TtMA | 8.24 | — |
| PLGA-TtMA | — | 8.13 |
| BPO | 0.81 | 0.81 |
| PGPR | 1.78 | 1.54 |
| Toluene | 8.12 | 8.12 |
| Total | 18.95 | 18.60 |

Internal, aqueous phase

| | | |
|---|---|---|
| H₂O | 80.57 | 80.91 |
| K₂SO₄ | 0.48 | 0.49 |
| Total | 81.05 | 81.40 |
| Density, g/cc | 0.104 | 0.129 |
| Modulus, MPa | 0.29 ± 0.01 | 0.62 ± 0.02 |
| T_{g}, ° C. | 71.5 | 71.9 |

PolyHIPE Characterization

The polyHIPE densities were determined gravimetrically from the sample mass and volume. The porous structure were characterized using secondary electron (SE) imaging in scanning electron microscopy (SEM, FEI Quanta 200) of gold-palladium-coated cryogenic fracture surfaces. The fracture surfaces were generated by immersing the samples in liquid nitrogen, waiting 2 minutes, removing the samples and pulling them from opposite sides with tweezers. The macromolecular structure was characterized using Fourier transform infrared (FTIR, Bruker Equinox 55 FTIR) from 500 to 4000 cm⁻¹. Pieces of the dry polyHIPE were mixed with KBr (0.33 wt % polyHIPE) and the mixture was ground using a mortar and pestle. The mixture was then pressed into transparent pellets and evaluated using FTIR in transmission. The polymer glass transition temperature was evaluated using differential scanning calorimetry (DSC, Mettler DSC-821e calorimeter) under nitrogen. The mass of the samples was 5 mg and the runs were between 0 and 180° C., at 10° C./min. The Tg was taken from the second heat. Compressive stress-strain tests were conducted (Instron 3345) at room temperature on samples of approximately 1×1×1 cm³. The measurements were carried out until a strain of 70% was reached, at a strain of 10%/min. The static compressive modulus was determined from the linear slope of the compressive stress-strain curves at low strains.

Results and Discussion

PLA-PH and PLGA-PH Synthesis: Fourier transform infrared spectroscopy (FTIR) confirmed the substitution of the OH groups in the synthesis of PLA-TtMA and PLGA TtMA. PLGA-PH exhibit a broad OH stretching band at 3487 cm⁻¹. On the other hand, PLA-PH did not exhibit a broad OH stretching relatively at 3487 cm⁻¹. The FTIR spectra also exhibit: an asymmetric C—O—C stretch at 1142 cm⁻¹; asymmetric and symmetric CH₂ stretching bands at 2974 to 3010 cm⁻¹ and a strong C═O stretching band at 1765 cm⁻¹. Both PLA-PH and PLGA-PH exhibit C═C stretching bands at 1655 cm⁻¹ formed as a result of the methacrylation. All the polyHIPEs exhibit a band at 1464 cm⁻¹ that is associated with the C—H group and a band at 1398 cm⁻¹ indicating the presence of C—O band.

PolyHIPE Structure: The densities of PLA-PH and PLGA-PH are 0.104 and 0.129 g/cc, respectively (see, Table 4). The morphologies of PLA-PH and PLGA-PH exhibit a typical polyHIPE open structures that can be associated with the relatively high content of the surfactant in the organic phase. It has been shown that open structures are obtained when the concentration of the surfactant exceeds 5% in the external phase. As can be seen in Table 4, PGPR accounts for about 8 to 9% of the external phase.

Thermal and Mechanical Properties of the polyHIPEs: The DSC thermograms of PLA-PH and PLGA-PH exhibited one glass transition temperature which were calculated from the second heating and are listed in Table 4. The T_{g} for PLA-PH was 71.5° C., relatively close to the literature value of 65° C. PLGA-PH was expected to exhibit a lower Tg, between 35° C. and 55° C., but the measured Tg was relatively broad centered at 71.9° C.

The polyHIPE modulus (see, Table 4) was calculated from the slope at low strains. Since the relative modulus (foam modulus divided by wall modulus) for open cell foams is related to the relative density (foam density divided by wall density) squared, the higher modulus of PLGA-PH (0.46 MPa vs. 0.21 MPa) reflects its higher density (0.129 g/cc vs. 0.104 g/cc).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A porous monolith comprising a crosslinked polymer, wherein said crosslinked polymer comprises lactic acid residues, and having a microstructure that is templated by a polymerized high internal phase emulsion (HIPE).

2. The porous monolith of claim 1, wherein a content of said lactic acid residues in said crosslinked polymer is at least 40 wt %.

3. The porous monolith of claim 1, wherein said lactic acid residues form a part of a macromonomer residue, and a content of said macromonomer residue in said crosslinked polymer is at least 40 wt %.

4. The porous monolith of claim 3, wherein said crosslinked polymer comprises 40 wt % glycolic acid residues or less.

5. The porous monolith of claim 3, wherein said macromonomer is represented by general Formula I: 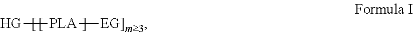
wherein:
HG is a hub-group;
m is a natural number equal or larger than 3;
PLA is a poly(lactic acid) chain; and
EG is an end-group.

6. The porous monolith of claim 5, wherein said end-group is a diene group, a methacrylic group, an acrylic group, or an allyl group.

7. The porous monolith of claim 6, wherein said end-group is a methacrylate group.

8. The porous monolith of claim 5, wherein said hub-group is a polyol group.

9. The porous monolith of claim 8, wherein said polyol is selected from the group consisting of pentaerythritol, glycerol, erythritol, threitol, sorbitol, galactitol, fucitol, iditol, idose, arabitol, ribitol, mannitol, cyclitol, inositol, pyrogallol, trimethylolpropane, trimethylolmethane, trimethylolethane, di(trimethylolpropane), dipentaerythritol, tripentaerythritol, xylitol, volemitol, isomalt, maltitol, lactitol and maltotriitol.

10. The porous monolith of claim 9, wherein said polyol is pentaerythritol.

11. The porous monolith of claim 5, wherein:
EG is a methacrylate group;
HG is a pentaerythritol residue;
m is 4; and
n is a positive number greater than 1.

12. The porous monolith of claim 11, wherein n is 3.

13. The porous monolith of claim 1, wherein said crosslinked polymer comprises residues of an additional monomer selected from the group consisting of glycolic acid, glycolide, an acrylic ester (acrylate), a methacrylic ester (methacrylate), an unsaturated nitrile, a styrenic monomer, a vinyl ester, a vinyl ether, a conjugated diene, an olefin, a halogenate such as vinyl chloride or vinylidene chloride, an allyl, and any mixture or combination thereof.

14. The porous monolith of claim 13, wherein said additional monomer is 2-ethylhexyl acrylate.

15. The porous monolith claim 1, further characterized by at least one of:
a density lower than 0.3 g/cc;
a gel content of at least 50%;
a modulus of at least 0.5 MPa; and/or
a compressive failure strain of at least 10%.

16. A process of preparing the porous monolith of claim 1, the process comprising:
providing an organic phase that comprises a macromonomer having at least three end-groups, said macromonomer comprises a plurality of lactic acid residues;
mixing said organic phase with an aqueous phase and a surfactant, thereby obtaining a HIPE; and
polymerizing said HIPE,
thereby obtaining the porous monolith.

17. The process of claim 16, wherein said polymerizing comprises heating said HIPS to a temperature ranging from about 45° C. to about 95° C.

18. The process of claim 17, wherein said organic phase further comprises an initiator.

19. The process of claim 16, wherein said organic phase further comprises an organic solvent.

20. The process of claim 16, wherein said organic phase further comprises an additional monomer.

21. The process of claim 16, wherein said aqueous phase further comprises a divalent cation.

22. The process of claim 16, further comprising, subsequent to said polymerizing, subjecting the porous monolith to Soxhlet extraction.

23. The process of claim 16, further comprising, subsequent to said polymerizing, drying the porous monolith under ambient or reduced pressure and/or under ambient or elevated temperature.

24. An article of manufacturing comprising the porous monolith claim 1.

25. The article of claim 24, selected from the group consisting of a tissue scaffold, an implantable medical device, a drug delivery and controlled drug release device and a system for controlled substance release device for agriculture.
